(19) United States
(12) Patent Application Publication
(10) Pub. No.: US 2023/0409752 A1
(43) Pub. Date: Dec. 21, 2023

(54) SYSTEM AND METHOD FOR LOCALIZED PERMISSION-BASED SHARING OF PERSONAL INFORMATION

(71) Applicant: Simpello LLC, Monticello, IN (US)

(72) Inventors: William Benjamin Robertson, Monticello, IN (US); Aamar Qureshi, Katy, TX (US)

(73) Assignee: Simpello LLC, Monticello, IN (US)

(21) Appl. No.: 18/460,010

(22) Filed: Sep. 1, 2023

Related U.S. Application Data
(63) Continuation-in-part of application No. 18/338,618, filed on Jun. 21, 2023.
Application No. 18/338,618 is a continuation of application No. PCT/US2021/064309, filed on Dec. 20, 2021.
(60) Provisional application No. 63/128,956, filed on Dec. 22, 2020.
(60) Provisional application No. 63/505,245, filed on May 31, 2023.

(51) Int. Cl. G06F 21/62; G06F 21/32; G06F 3/01; G06Q 20/40

(52) U.S. Cl. CPC G06F 21/6272; G06F 21/32; G06F 3/017; G06Q 20/40145

(57) ABSTRACT

A just in time personal information sharing system employs short-range wireless communication to detect the presence of a user and identify them prior to sharing the user's information. The user stores personally identifying information within their user device and controls which parties it may be shared with. Subsequently when a user is detected within a location using a wireless terminal, the user's presence is verified using a biometric profile, and if confirmed, then the user's personally identifying information is shared with the other transacting party for temporary use in completing a desired transaction. In this manner, no transacting party is required to maintain user information, and in addition, a user controls their own information and its sharing without the need for arduous user input to facilitate the same.

### CROSS-REFERENCE TO RELATED APPLICATIONS

The present application is a continuation-in-part of U.S. patent application Ser. No. 18/338,618 filed Jun. 21, 2023, which is a continuation of International Patent Application No. PCT/US2021/064309, filed Dec. 20, 2021 which claims the benefit of U.S. Provisional Application No. 63/128,956 filed Dec. 22, 2020, each of which is hereby incorporated by reference.

This application also claims the benefit of U.S. Provisional Application No. 63/505,245 filed May 31, 2023, which is hereby incorporated by reference to the extent not inconsistent.

### FIELD OF THE INVENTION

The present invention generally relates to a localized permission-based system and method for selectively and securely storing and sharing a user's personal information. This personal information may include personal identifying information, contact information, payment information, reservation information, travel information, credit information, access information, health information or the like. The personal information is stored in a decentralized user-controlled environment and is selectively provided to requesting third-parties in response to a verified and approved request for specific information. More particularly, the present invention pertains to a system and method for selectively sharing a user's personal information from a local user-controlled environment with a third-party following a biometric verification and authorization facilitated via a trusted intermediary. The personal information data is only temporarily accessed and utilized on an as needed basis by the requesting party to reduce and/or eliminate data privacy concerns and the associated burdens that come with storing such personal information.

### BACKGROUND

Since the advent of the dot corn era, websites and businesses have been on an endless journey to collect data. Whether it be a user's name and address, email, credit card information or purchasing history, all of this data could be mined and monetized for profit, including through targeted marketing, by making transactions much easier for the user to complete and selling such information (either in individual or aggregated form). In combination with this trend, nearly every store now has a loyalty or rewards program, mobile application, user account, or otherwise requires customer information to provide streamlined transaction processing or the like.

Unfortunately, consumers have seen all too frequently that freely sharing their sensitive personal information can have adverse consequences, such as in the event of a cyber attack or data breach, when the user's information may be accessed by malicious actors seeking to exploit it for their own personal gain. This often results in fraudulent credit cards being opened or unauthorized transactions occurring, all of which can lead to negative consequences and substantial headaches for the user. The responsible company must expense significant resources to address the issue as well as facing substantial consumer backlash and the resulting reputational damage.

Furthermore, as a result of the harm previously done to users through data breaches, businesses have begun to face stricter regulations from many jurisdictions around the world, including most prominently the European Union. These regulations apply whenever a country's citizens' data is collected and/or stored. The potential liabilities and regulatory risks, which include substantial fines, as well as the framework needed to comply presents a significant challenge to the modern business' information technology (IT) department as well as its bottom line.

Accordingly, many users and businesses would benefit from a solution that alleviates many of the above concerns while maintain just in time access to a user's data when needed so that that data need not be persistently stored, thereby reducing risk. What is needed is a decentralized system having user permissions stored or requested on demand which is otherwise virtually transparent to the user and operates to verify the user and deliver the necessary information to the requesting party in a just in time manner for use and prompt disposal rather than long-term storage.

### BRIEF DESCRIPTION OF THE DRAWINGS

FIG. 1 is a diagrammatic view of one embodiment of a localized permission-based information sharing system according to the present invention.

FIG. 2 is a flowchart illustrating one set of steps involved in an illustrative process for provisioning a mobile phone for use within the system shown in FIG. 1, according to one form of the present invention.

FIG. 3 is a flowchart illustrating one set of steps involved in an illustrative process for completing a verified personal information exchange using the system shown in FIG. 1, according to one form of the present invention.

### DETAILED DESCRIPTION OF THE INVENTION

For the purposes of promoting and understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

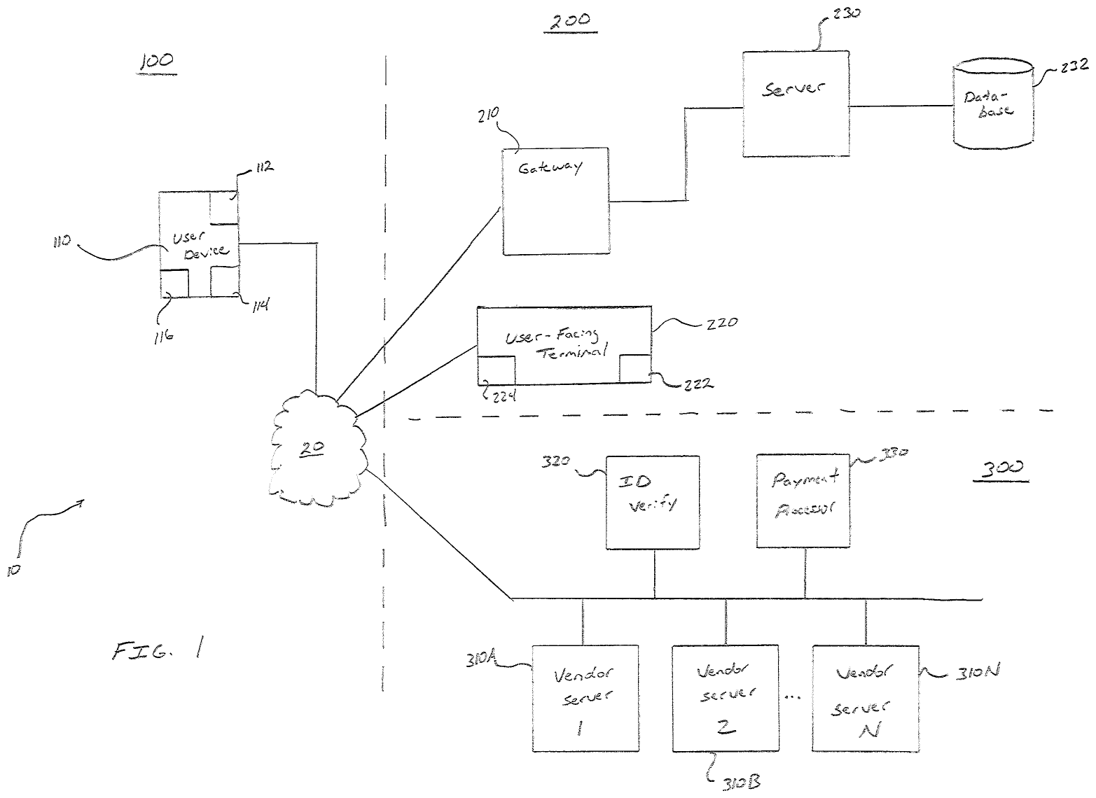

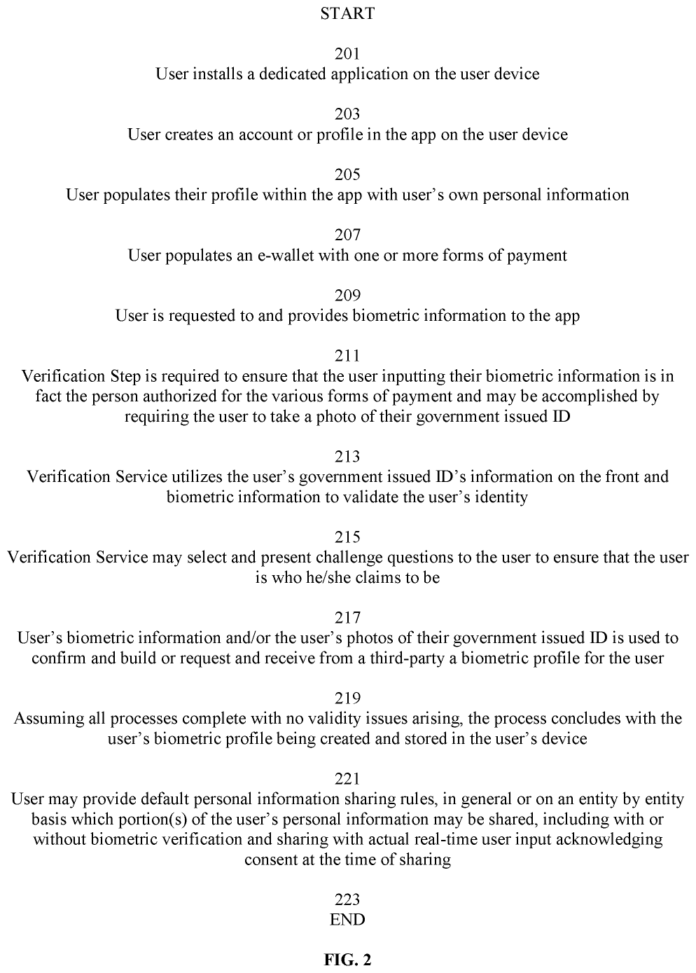

Shown in FIG. 1 is one embodiment of a localized permission based personal information sharing system which advantageously permits a user to securely store their personal information locally under their custody and control and temporarily provide it to requesting authorized users on demand for prompt use and disposal. Such personal information may include, but shall in no way be limited to or required to include personal identifying information, contact information, payment information, credit information, access information, health information, travel credentials, booking information or the like. In a further form, some portion of the user's personal information may be stored elsewhere, but not a sufficient enough amount to be concerning and/or useful for nefarious purposes should it fall into the wrong hands. This way, collection of at least some portion of the user's personal information from the user is required for any utilization.

The system 10 includes a user side 100, a service side 200 and a third-party side 300, which are merely logical divisions based upon which entity controls the hardware, software and data flow within those areas of the system 10, and do not necessarily indicate the location of the various components. For purposes of communication within system 10, it shall be appreciated that a network 20 and other known methods of data exchange, such as wireless transmission (including Bluetooth® or other known point to point standards) may be utilized, with network 20 potentially not belonging, either in whole or in part, to any logical side. Various communication pathways, such as those shown as lines or wireless waves, connecting to and through network 20, transmit data amongst devices and from one logical side to another. Network 20, as shown in this embodiment, can be in the form of a Local Area Network (LAN), Municipal Area Network (MAN), Wide Area Network (WAN), such as the Internet, a satellite or cellular network, any combination of the foregoing, or such other network arrangement as would occur to those skilled in the art. It should be understood that more or fewer devices than are shown in FIG. 1 can be coupled together by network 20 and in various alternate arrangements.

In the illustrated form, network 20 may include numerous separate networks and multiple pathways, including in part the Internet and a cellular phone network which may be the universal mobile telecommunications system (UMTS), global system for mobile communication (GSM), and a code division of multiple access (CDMA) network, or similar technology. The cellular phone network within network 20 utilizes cell tower to establish a wireless bi-directional transmission link between user device 110 and other devices connected thereto, including those shown in FIG. 1, which may comprise a wireless data link, such as the Evolution-Data Optimized (EVDO), Enhanced Data rates for GSM Evolution (EDGE), 3G, 4G, LTE, 5G, WiMax, Ultra-Wide Band, orthogonal frequency-division multiple access (OFDMA) or other wireless data connection.

Turning to the user side 100, the primary component according to the illustrated embodiment is user device 110, which in the illustrated embodiment is a user's smartphone, such as for example an Apple iPhone® running Apple's iOS operating system or a Samsung® or other brand smartphone running the Android operating system. It shall be appreciated that other electronic devices may be utilized in addition to or in place of user device 110, such as a smart watch, a tablet, a specialized wireless token, implant, a Bluetooth appliance or the like. In the illustrated embodiment, user device 110 includes at least one biometric sensor 112, such as a camera, infrared camera, true depth camera, facial recognition sensor, fingerprint reader, palm/hand scanner, iris scanner, voice recognition microphone or some other known biometric or identity confirming sensor. In other embodiments a separate biometric sensor 112 may be utilized, or the biometric sensor 112 may be not be required. In one form, the user device 110 also includes an installed application 114 which in one form may be provided by the service provider operating service side 200, or in another form may be provided by an operator on third-party side 300 (optionally including functionality provided by the service provider operating service side 200). The installed application 114 may be provided through a known mobile application distribution platform, such as Apple's App Store or the Google Play Store. Alternatively, the functions of the application may be partially or totally integrated into the installed application 114, resident within the operating system or otherwise within the user device 110 or within a webpage, applet or the like.

User device 110 is preferably capable of mobile voice and/or data communication over a network of cell towers or other network(s), such as network 20, over which mobile phones such as user device 110 are known to be capable of operation as well as wireless communication through conventional Wi-fi networks. In addition to the standard voice function of a mobile phone, user device 110 preferably supports many additional services, and accessories, such as SMS for text messaging, e-mail, packet switching for access to the Internet, third-party application download, Bluetooth, infrared, NFC and/or GPS. It shall be appreciated that a vast number of user devices, such as user device 110, are contemplated for use within system 100, but that only one is shown for ease of understanding.

User device 110 also includes a user data vault 116 which may be a segment of memory located within the user device or securely accessible by the user device (but located remotely) where the user's personal information may be securely stored. In one form, this personal information is stored in a secured and/or encrypted form to protect it from unauthorized access.

Moving to the service side 200, included are a gateway 210, a user-facing terminal 220 and a server 230, which includes or is connected to a database 232. Gateway 210 is illustrated as being a specialized server for facilitating the sharing of personal information and is connected to network 20. It shall be appreciated that in alternate forms gateway 210 and/or server 230, as well as any other server described herein, may be implanted as one or more conventional servers, virtual machines or one or more virtual services operating in the cloud, such as using Amazon Web Services (AWS) or the like.

User-facing terminal 220 is a device for local communication with user device 110 when user device 110 comes into proximity of user-facing terminal 220. User facing terminal 220 acts to verify the expected user's presence in conjunction with user device 110 to enable the trusted temporary sharing of personal information with user-facing terminal 220 and various other local components of the remainder of system 10, as will be described below. In order to achieve the objects of the business logic described herein, gateway 210 works in conjunction with terminal 220. User-facing terminal 220 may be an Apple iPad® running Apple's iOS operating system or a Samsung®, another brand tablet running the Android operating system or a dedicated hardware solution or combination thereof. It shall be appreciated that other electronic devices may be utilized in addition to or in place of terminal 220, such as a smart display, smart television, Bluetooth appliance, specialized appliance or the like. Terminal 220 also includes a biometric sensor 222, which in the illustrated embodiment is a camera that is oriented toward the transaction zone where the customer typically stands to complete a transaction. In one form, the camera is a high-resolution camera, with a lens and/or view field of view so as to span at least the entire transaction area. In addition, the biometric sensor 222 may also include a LIDAR or other sensor type so as to assist in the selected type of biometric verification, which in the illustrated embodiment is facial recognition. Alternatively, the biometric sensor 222 may be one of any other known types of biometric sensors, including those identified herein as alternatives to sensor 112.

In addition, terminal 220 may be equipped with a very granular proximity detection system, such as that disclosed in PCT/US2019/032774 entitled “Radio Frequency Antenna and System for Detecting Presence within a Strictly Defined Wireless Zone, the entirety of which is hereby incorporated by reference. Proximity detection system employs short-range wireless communication to detect the proximity of a user device within a strictly defined wireless zone, such as a transaction zone, and as a result trigger a desired action, which in the present invention is to either provide authorization for a transaction or biometric verification to proceed, or to identify the precise area of the transaction zone in which the user is standing in order to inform terminal 220 as to which region of the image generated by camera the user's face should appear in. By focusing upon a selected region intelligently, the precision, security and speed of the biometric verification can be further improved. In other forms, the functions of terminal 220 may exist outside and independent of a POS terminal.

In one form, the terminal 220 includes a display and also includes an installed application 224 which in one form may be provided by the operator of third-party side 300 (optionally including functionality provided by the service provider operating service side 200). As is described above, the installed application 224 may be provided through a known mobile application distribution platform and functions of the application 224 may be partially or totally integrated into the installed application, resident within the operating system or otherwise within the terminal 220 or within a webpage, applet or the like. Terminal 220 is preferably connected to network 20 via a physically networked and/or wireless connection. The connection of terminal 220 to network 20 or otherwise enables terminal 220 to communicate with switch 210 as will be further described herein.

Server 230 operates in conjunction with gateway 210 to implement the business logic of the system 10 described herein, including maintaining user accounts, user preferences, vendor accounts, audit trails of data sharing and the like. Computers and devices, such as gateway 210, user-facing terminal 220, server 230 and other devices within third-party side 300 may each include one or more processors or CPUs and one or more types of memory. Each processor may be comprised of one or more components configured as a single unit. Alternatively, when of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more Xenon® processors supplied by INTEL Corporation of 2200 Mission College Boulevard, Santa Clara, Calif. 95052, USA.

It should be understood that any devices shown in system 10 may be arranged to include both a client and server or comprise dedicated hardware or a combination of conventional hardware adapted using software. It should also be understood that while numerous devices and servers are illustrated, more or fewer may be utilized in alternative embodiments, including the integration of two or more device illustrated into one, and that numerous user-facing terminals 220 shall be provided given their local nature, with one or more being potentially located within each affiliated store, business, vendor or the like. Moreover, depending upon the traffic and capacity required, numerous servers such as server 230 may be provided for to collectively share the workload and balance the efforts of server 230 illustrated and described herein or multiple virtual cloud base services may be used in place of all or a portion of server 230.

With respect to third-party side 300, included are any number of Vendor Servers (including Vendor Server 310A, 310B and 310N), which are operated and controlled by individual third-party entities. For example, Vendor Server 310A may belong to an airline, Vendor Server 310B may belong to a coffee shop and Vendor Server 310N may belong to a hotel. It shall be appreciated that many more Vendor Servers may be included within system 100 depending upon the number of third-party vendors which desire to securely receive and act upon a user's personal information in order to transact with and serve one or more of the users of system 100. In other forms, these Vendor Servers 310 may be one or more virtual services operating in the cloud, such as using Amazon Web Services (AWS) or the like.

Additionally, provided are an Identity Verification Source 320 and a Payment Processor 330. Identity Verification Source 320 is a third-party trusted server or service which enables system 100 to verify a user's identity, such as by using a driver license, passport or other government authenticated document, card or the like. The Identity Verification Source 320 may be a governmental or private server or service, such as a state driver's license verification system, credit reporting service or the like which enables a user's identity to be verified with the requisite level of trust. In addition, Payment Processor 330 may be a payment system which enables the processing of transactions for goods and services which may occur between a user and third-party within system 100. These also may be may be one or more virtual services operating in the cloud.

It shall be understood that many of the descriptions herein with respect to a retail environment are meant for illustrative purposes and that the concepts herein are generally applicable to other transactions and are not limited to only commercial transactions or retail purchases. For the avoidance of doubt, commercial transactions shall include, but by no means be limited to, purchases of goods, purchases of services, credit card transactions, debit card transactions, gift card redemptions, e-wallet transactions, crypto currency transactions, wire transfers, ACH transfers and the like.

Turning to FIG. 2, one set of steps involved in illustrative process for provisioning a user device 110 for use with gateway 210 and terminal 220, as well as the rest of system 10, is provided. The process begins at start point 201 with the user installing a dedicated application 114 on their user device 110, such as by using an application source such as the Apple App store or the Google Play store. The application 114 may be distributed by the operator of service 200, a credit card issuer, a payment processor, a mobile phone provider, a retail store, an airline, a hotel, or some other third-party integrator. Once installed, the user creates an account or profile with server 230 using the application 114 on their user device 110 (stage 203). Within the account or profile, but only stored in complete form locally on the user device 110 within user data vault 116, the user populates their profile within the application 114 with the user's own personal information (stage 205). The server 230 may be advised of what pieces of information are shared by the user, and stored within the user's data vault 116, but the actual personal information itself is not transmitted to or made known in complete form to the server 230 or other devices within system 100.

A certain threshold level of information must be shared for the system 100 to function, but other pieces of personal information may be shared by certain users and not by others at their preference, however, in such case certain additional functions may not be enabled as a result of such choice. Again, this personal information may include, but shall in no way be limited to or required to include, personal identifying information, contact information, payment information, credit information, health information, driver's license or government issued ID, travel credentials, booking information or the like.

In addition to the personal information provided, an e-wallet with one or more forms of payment, such as credit card, debit card or other suitable payment information may be provided by the user within the application 114 on user device 110 (stage 207). It shall be appreciated that this information may include a credit card number, expiration date and security code, or other alternative information sufficient to enable to payment, such has Venmo, PayPal or the like. This information may be confirmed with Payment Processor 330, or merely maintained, either in whole in part, within data vault 116 for subsequent use. Next, the user is requested to and provides biometric information for themselves to the application (stage 209). This information may be input using a sensor 112 resident on the user device 110, as has been described above. Alternatively, an auxiliary sensor may be provided to the user which is usable with the phone, such as by Bluetooth, USB or other hardwired connection to allow the user to input their biometric information. The auxiliary sensor may be maintained by the user or returned to the service provider, depending upon cost. In other forms, the user may be required to provide their biometric information at a designated location using other equipment.

In a further form, a verification step is required to ensure that the user inputting their biometric information is in fact the person authorized for the various payment methods. This may be accomplished by requiring the user to take a photo of their government issued identified using the user device 110 (stage 211). The photo would may include the user's photo and information on the front of the ID and may also include the barcode or other independently verifiable information thereon, which can be validated by using various known identity verification services. Subsequently, Server 230 attempts to verify the user's upload of their government issued ID and biometric information using ID Verification Server 320 to confirm the authenticity of the ID (stage 213). Verification Server 230 may be a third-party service, a federal government service or some other service operating from a trusted government database of information. Examples include ID.me or Persona (available at withpersona.com). Alternatively, or additionally, Gateway 210 and/or Server 230 may select and present challenge questions to the user via the mobile application 114 to ensure that the user is who he/she claims to be (stage 215). Examples of these questions include street names the user previously lived on, cities in which the user previously resided, the name of entities to whom the user has a loan balance with, or other questions which is often presented in an automated fashion during a background check, credit check or the like.

Thereafter, the server 230 utilizes the user's biometric information input in stage 209 and optionally 211, as well as potentially the user's photos from the government issued ID, to confirm and build or request and receive from a third-party a biometric profile for the user (stage 217). The biometric profile of the user may be developed in part using the other components of service side 200, but shall be protected for privacy concerns. Assuming all processes complete with no validity issues arising, the process concludes with the user's biometric profile being created and stored in the user's user device 110, such as within data store 116 (stage 219). Preferably, this biometric profile is sufficient to enable a user to be verified, but not sufficient to enable a reverse construction of the user's appearance, so as to make any attempted fraud virtually impossible. Part of the biometric profile may be stored by gateway 210 or server 230, with at least the remainder stored within the user device 110 to enable a complete copy to be complied for use when desired and permission from the user device 110 is present. This charring function enables some data to be stored without invoking regulations, and also provides from increased efficiency and security.

In addition, the user may optionally provide default personal information sharing rules to gateway 210 or server 230, such as via application 114, specifying in general or on an entity by entity basis which portion(s) of the user's personal information may be shared with which entities, including both sharing without biometric verification, sharing without biometric verification and sharing with actual real-time user input acknowledging consent at the time of each sharing (stage 221). For example, a user may be willing to share with a certain cocktail bar their name and loyalty account number without verification or permission, but may require their biometric verification for payment information being shared, and perhaps even their own express consent at the time of sharing to share their age, birthdate, driver's license information or the like. The process ends at end point 223.

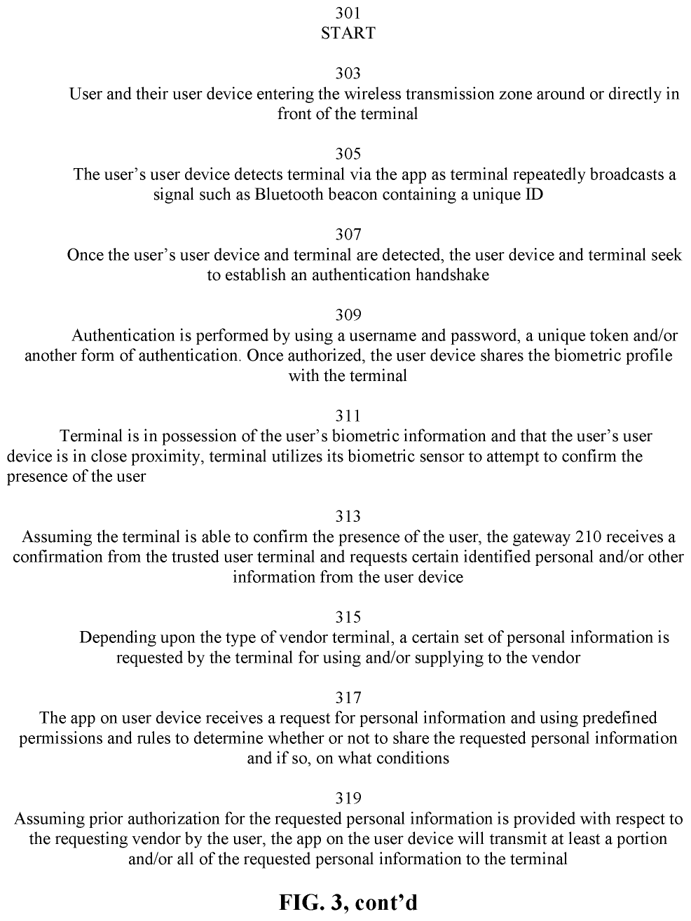

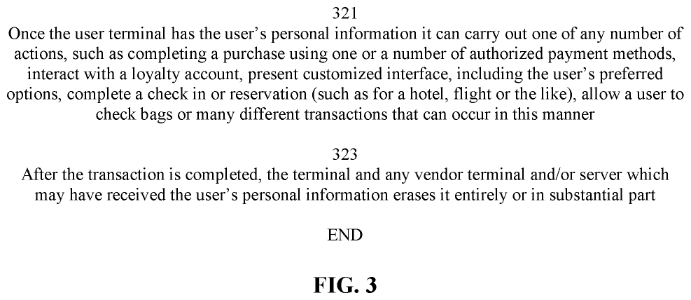

Next, as illustrated in FIG. 3, one set of steps involved in an illustrative process for completing a verified personal information exchange using the system 100 is provided. It shall be appreciated that it is known that consumers have various loyalty accounts with vendors, and the existence of such accounts for a user and a vendor are presumed. These accounts may continue in their current form, but personal information could be stripped from permeant storage and only a unique user ID maintained in association with all of the data such that the personal information can be requested, used and removed when needed, thereby reducing the vendor's exposure and liability for maintaining such information, as well as enhancing the user's privacy and vulnerability to a data breach. This scheme effectively transfers each user in a vendor's database to unknown users, but can quickly transition them into known users when necessary, such as when the user arrives onsite at the vendor's location.

The process begins at start point 301 with the user and their user device 110 entering the wireless transmission zone around or directly in front of terminal 220 (stage 303). In one form, the user's user device 110 detects terminal 220, such as via application 114, as terminal 220 repeatedly broadcasts a signal, such as a Bluetooth beacon containing a unique ID (stage 305). In alternate forms, the terminal 220 may detect the user device 110, with a similar effect. However, in the illustrated embodiment the user need not remove their user device 110 from their pocket, purse or the like or provide any input to the user device 110 to accomplish this step. In a further form, a more precise presence detection system, as described above, may be included to strictly define a connection zone, such as in front of a transaction counter.

Once detected, the user device 110 and either the gateway 210 and/or the terminal 220 seek to establish an authentication handshake (stage 307). This may be performed by using a username and password, a unique digital token, or some other known manner of authorization/authentication. Once authorized, the user device 110 shares the biometric profile for the user stored with user data vault 116 with terminal 220 (stage 309). This may be accomplished in one of many ways, all of which may be secured and/or encrypted. In one form, the user device 110 transmits the user's biometric token to the gateway 210 over network 20, whereby gateway 210 may then pass it along to terminal 220. In another form, the user device 110 may transmit the user's biometric token to terminal 220 directly, without using network 20, such as via Bluetooth or some other suitable point to point transmission method. Alternatively, the user device 110 may transmit the user's biometric token to terminal 220 via network 20. In a further form, the user device 110 may split the user's biometric profile into two or more non-complete but re-combinable parts and transmit a first portion along one path and a second portion along a separate and distinct path, thereby providing additional security. Which method is utilized may depend upon service, vendor or user preferences and settings, or may be dictated at least in part by the types of connections available to user device 110, gateway 210 and terminal 220.

In yet another form, the user device 110 may only transmit a portion of the user's biometric profile, which may then be combined with a non-complete portion of the biometric profile stored in, known to or accessible by the gateway 210 to arrive at the complete biometric profile for subsequent transmission to and use by terminal 220. In this manner, the user's biometric profile is charred, meaning that only a non-complete biometric profile is ever persistently stored outside of the user's device, thus requiring some portion from the user's device to be provided before the biometric profile is in any way useful.

Now in possession of the user's biometric profile, and aware of the user's user device 110 being in close proximity, terminal 220 utilizes its biometric sensor 222 to attempt to confirm the presence of the user 220 (stage 311). It shall be appreciated that various methods of biometric verification exist, including facial recognition, palm scanning, iris scanning and fingerprint reading, and the use of any of these models or other known methods is contemplated. For example, in the present embodiment in which facial recognition is utilized, the biometric sensor 222 of terminal 220 may create the model by pinpointing and measuring facial features from a live video stream showing the user. In further form, a 3-D facial recognition model may be utilized. Alternatively, voice recognition, fingerprint recognition, iris scanning or the like may be utilized, so long as the appropriate information for performing such a match is provided for in the user's biometric profile and is authorized by the service and the user.

Assuming the terminal 220 is able to do so, the gateway 210 receives a confirmation from the trusted user terminal 220 and then requests certain identified personal information and potentially other information from user device 110 (stage 313). In addition, the terminal 220 may also request or retrieve information from gateway 210 or server 230.

Depending upon the type of vendor at which the terminal 220 is located, a certain set of personal information is requested by the terminal 220 for utilization and/or supplying it to the respective vendor's Vendor Server 310A (stage 315). This personal information may include a unique identifier (or something translatable into a unique identifier) which links the user to a profile within the vendor's Vendor Server 310A. In addition, depending upon the transaction type, additional data such as various specific pieces of personal information may also be requested. The application 114 on user device 110 then receives the request for personal information and using predefined permissions and rules determines whether or not to share the requested personal information, and if so, on what conditions (stage 317). Assuming prior authorization for the requested information is provided with respect to the requesting vendor by the user, then the application 114 on the user device 110 will transmit at least a portion, and perhaps all, of the requested information to the terminal 220 (stage 319). Again, this may be sent directly, such as via Bluetooth or some other point to point protocol, or indirectly, such as via gateway 210 via network 20. Once the user terminal 220 has the user's personal information it can carry out one of any number of actions, such as completing a purchase using one or a number of authorized payment methods, interact with a loyalty account, present customized interface, including the user's preferred options, complete a check in or reservation (such as for a hotel, flight or the like), allow a user to check bags or many different transactions that can occur in this manner (stage 321). It shall be appreciated that depending upon the particular transaction(s) being implemented that one or more of Vendor Servers 310 may be selected so as to be associated with the appropriate vendors to provide those functions. As part of this stage, the terminal 220 may selectively share the user's personal information with Vendor Server 310A (or another) to complete the desired exchange/transaction using the vendor's back end systems. In a further form, additional user input may be required to complete a transaction, or additional user authorization may be required to share additional information needed or desired by terminal 200 and the vendor. This input can be completed on the terminal 220, such as by use of the user interface and/or touchscreen. After the transaction is completed and no further processing is anticipated or required, the terminal 220 and any Vendor Server which may have received the user's personal information erase it either entirely or in substantial part (stage 323). In this manner, the sole location of the user's personal information remains the user's device 110.

One main advantage of this embodiment of the present invention is the local establishment of a biometric profile within the memory of the user's user device 110 and the passing of this biometric profile to the terminal 220 when requested and authorized by the user. This establishes a decentralized system where the user controls their information and trust is placed in the terminal to locally verify the received biometric information before authorizing the release of the user's personal information or the processing of a transaction.

Moreover, in certain forms, the entire process of FIG. 3 can be completed without the user removing the user device 110 from their pocket, purse or the like or provide any input to the user device 110 to accomplish the steps therein. Doing so eliminates the complications of a user being required to authenticate themselves using a vendor terminal or kiosk separately using their phone, by scanning a QR code, or through some other more involved authentication process.

In the case of a simple purchase, the process of FIG. 300 may include the selection of a card or account, from the list of authorized ones permitted for sharing with the vendor, may be designated by the user through direct input into terminal 220 or using a default previously specified. In such event, the terminal 220 can effectuate the transaction without any user input to their user device 110, and in some cases using user device 110 and its stores information and even wireless or cellular connection.

In a further and even more secure form, the process of FIG. 3 may include an additional factor of authentication prior to clearing the transaction in stage 321. Specifically, the user may be required to input during the initial set up of FIG. 2 a selected gesture, such as waving, tapping their nose, winking, or some other easily recognizable and distinct movement or another biometric indicator such as voice. Thereafter, the terminal 220 would attempt to detect the user performing this gesture or matching the additional biometric indicator, such as voice, by prompting the user's to vocally confirm. In addition, the terminal 220 may prompt the user to perform this gesture or speak at the conclusion of another stage, or at some point adjacent thereto, if it has not previously been identified.

In various embodiments, thresholds may be set for the requirement of further biometric verification. For example, for common transactions known to occur for a given user, no biometric verification may be required. However, for uncommon transactions above a certain threshold, such as $50, or $100, or for additional controls such as on the purchase of controlled substances, such as alcohol, cigarettes or pharmaceuticals or other medications, the biometric verification step may be required.

This disclosure is applicable to all areas where the verification of an identifiable customer or other individual enables one or more desired transactions or secured action(s), such as a retail purchase, entrance or access to a structure, vehicle, venue, or any other type of restricted area. For routine sales transactions, such as a coffee purchase or fast-food items, the use of the proximity of a smartphone to a vending machine or sales counter combined with user input on the smartphone may be sufficient to authorize a sales transaction without adding another layer of confirmation to the transaction. However, a biometric verification according to the present invention may be required and serve as a two-factor authentication for other transactions where higher certainty is desired, where the user is not required to unlock or otherwise interact with the smartphone. In other situations, additional verification may optionally be added where the risk is greater, such as a purchase over a predetermined threshold, in an area outside of the user's hometown or the like.

It shall be appreciated that the system 10, in addition to sharing personally identifying information, may also be utilized to enable various exchanges of data without the user being required to interface with or interact with user device 10. For example, the system 10 may be utilized to allow access to a secured area or space, automatically commanded and elevator to take the user to the floor they are assigned in a secure and/or touchless manner, or allow a user to be presented with a customized display or menu at a restaurant for ordering. The potential applications are endless once the user's presence is identified and securely confirmed.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

What is claimed is:

1. A method for selectively sharing personally identifiable information using an authorization system, comprising the steps of:
storing a plurality of user profiles, each user profile associated with a user and linked with a biometric profile for the user, a user mobile device and a set of personally identifying information regarding the user;
storing a plurality of user permissions in conjunction with each user profile, wherein each user permission provides user consent for certain entities to receive at least a specified portion of the personally identifying information regarding the user associated with the user profile;
determining that a first user device associated with a first user has been detected at a first location associated with a transacting party using a first wireless terminal operating therein, wherein the first wireless terminal includes a biometric sensor and the first user device includes at least a portion of the set of personally identifiable information regarding the first user stored thereon;
receiving a first biometric profile which is associated with the user associated with the first user device at the first wireless terminal;
capturing a first biometric capture from at least one person located at the first location using the biometric sensor;
electronically comparing the first biometric capture to the first biometric profile and determining that the first biometric capture matches the first biometric profile;
receiving a requested set of personal information from within the set of personally identifying information which is requested by the transacting party;
confirming that the permissions associated with the user profile associated with the first user device permit the sharing of the requested set of personal information; and
retrieving at least a portion of the personally identifying information matching the requested set of personal information from the first user device; and
sending the requested set of personal information associated with the first user to the first wireless terminal for utilization by the transacting party.

2. The method of claim 1, wherein said determining that a first user device associated with a first user has been detected at the first location utilizes the detection by a wireless beacon signal broadcast by the first wireless terminal and received by the first user device.

3. The method of claim 1, wherein said determining that a first user device associated with a first user has been detected at the first location utilizes the detection by a wireless beacon signal broadcast by the first user device and received by the first wireless terminal.

4. The method of claim 1, wherein said confirming, retrieving and sending each occur without any user input into the first user device.

5. The method of claim 1, wherein a first part of the first biometric profile is transmitted to the first wireless terminal directly from the user device.

6. The method of claim 5, wherein a first part of the first biometric profile is transmitted to the first wireless terminal directly from the user device using a first wireless protocol and a second part of the second biometric profile is transmitted to the first wireless terminal from the first user device using a second wireless protocol, wherein the first wireless protocol is different from the second wireless protocol.

7. The method of claim 1, wherein at least a first part of the requested set of personal information associated with the first user is transmitted to the first wireless terminal directly from the user device using a first wireless protocol and a second part of the requested set of personal information associated with the first user is transmitted to the first wireless terminal from the first user device using a second wireless protocol, wherein the first wireless protocol is different from the second wireless protocol.

8. The method of claim 1, wherein the biometric profile associated with the user profile is stored at least in part on the user device associated with the user profile.

9. The method of claim 8, wherein the set of personally identifying information regarding the user associated with the user profile is stored at least in part on the user device associated with the user profile.

10. The method of claim 9, wherein the biometric profile associated with the user profile and the set of personally identifying information regarding the user associated with the user profile are stored in an encrypted form.

11. The method of claim 9, wherein the set of personally identifying information regarding the user associated with the user profile is stored entirely on the user device associated with the user profile.

12. The method of claim 11, wherein the set of personally identifying information regarding the user associated with the user profile is persistently stored solely on the user device associated with the user profile and not persistently elsewhere within the authorization system.

13. The method of claim 1, wherein at least a subset of the biometric profiles are validated using a third-party validation service.

14. The method of claim 1, wherein at least a subset of the biometric profiles are validated using at least one government issued photo identification.

15. The method for of claim 1, wherein the requested set of personal information comprises at least one of a date of birth, a social security number or a credit card number and an expiration date.

16. The method of claim 1, wherein each biometric profile comprises a facial recognition profile.

17. The method of claim 1, wherein the first wireless terminal is a tablet computer.

18. The method of claim 1, wherein the biometric sensor is a camera.

19. The method of claim 1, wherein the first user device is a smartphone or a smartwatch.

20. The method for claim 1, further comprising the step of detecting a first gesture from the user from whom the first biometric capture was taken from using the first wireless terminal and confirming that the first gesture matches a predefined gesture which is a part of the user profile associated with the first user prior to processing a transaction.

21. The method of claim 1, wherein the first wireless terminal deletes, at least in part, each element of the requested set of personal information associated with the first user after the transaction with the first user is complete.

22. The method of claim 1, wherein the first wireless terminal does not persistently store the set of personal information associated with the first user.
